(19) United States
(12) Patent Application Publication
(10) Pub. No.: US 2008/0133120 A1
(43) Pub. Date: Jun. 5, 2008

(54) METHOD FOR DETERMINING AND OUTPUTTING TRAVEL INSTRUCTIONS FOR MOST FUEL-EFFICIENT ROUTE

(76) Inventor: Ian D. Romanick, Portland, OR (US)

Correspondence Address: DILLON & YUDELL, LLP, 8911 N CAPITAL OF TEXAS HWY, SUITE 2110, AUSTIN, TX, 78759, US

(21) Appl. No.: 11/565,403

(22) Filed: Nov. 30, 2006

(51) Int. Cl. G01C 21/34; G06F 17/00

(52) U.S. Cl. 701/123

(57) ABSTRACT

A method provides a sequence of travel instructions that reports fuel-efficient routes calculated with regard to vehicle specifications, geography of terrain, and complexity of travel route. An operator selects the desired starting and ending location via a client interface of a software application. When the user selects “most fuel efficient route,” the fuel-efficient route (FER) utility of the application prompts for entry of the make, model, and year of the operator's vehicle. If the FER utility is embedded in an in-car navigation system, the information about the vehicle characteristics is preprogrammed during installation (e.g., at the factory). The FER utility uses a number of metrics and the vehicle's characteristics, to generate an optimal route for efficient fuel consumption. The invention provides means for an operator of a route planning application to optimize the driving directions for optimally predicted fuel usage.

### BACKGROUND OF THE INVENTION

1. Technical Field

The present invention relates in general to navigational route mapping, and in particular to a method and system for efficiently mapping routes for driving directions. Still more particularly, the present invention relates to a method and system for efficiently mapping routes for driving directions taking fuel usage into account.

2. Description of the Related Art

Navigation software applications are routinely utilized to obtain instructions to and from a user-defined destination. Travel routes are selected according to shortest distance, time of travel, as well as highway and toll access or avoidance. The user defines a starting location, destination, and mode of route. The route guidance unit displays travel instructions according to street and highway names, turns, exits, and distance to travel. The instructions are displayed in order of driving events. While this method of route planning has proven to be effective, travelers remain at a disadvantage due to excessive fuel consumption.

The problems associated with fuel consumption are manifold. Selecting a route based on distance of travel does not ensure efficient fuel usage. Routes often comprise many traffic signals, stop signs and various terrains that contribute to increased fuel consumption. Unnecessary or excessive use of vehicles strongly contributes to air pollution resulting in increasing health and environmental problems.

In addition to environmental and health risks associated with increased fuel usage, the consumer suffers financially. Fuel prices have multiplied within the last decade, with promise of continued increase. Increasing fuel efficiency is cost-effective. The fuel efficiency of all vehicles typically depends on speed. Some vehicles, especially hybrid and electric vehicles, perform much better at lower (e.g., non-highway) speeds. Traditional vehicles are more efficient at constant speeds. Ideally, selecting routes based on the speed of travel would be the most economic use of fuel. However, various motor vehicles respond differently given diverse road conditions. The geography of terrain and complexity of the route are major contributors to fuel consumption.

Several previous patents have attempted to create more efficient ways of vehicle route planning. Oikubo and Wataru (U.S. Pat. No. 7,127,350) discloses a navigation apparatus composed of a route search unit that obtains a route to take from a start point to a destination. The system detects a vehicle position, and provides route guidance based on the user defined start and destination. There are also car navigation devices known that display a roadmap around the vehicle's current position, calculate a route to take from a start point to a destination, and provide route guidance based upon the calculated route. In such a car navigation system travel instruction obtained through a route search is displayed on the map in a distinguishable manner. In addition, if there is any lane information available with regard to a guidance-requiring intersection, as the vehicle approaches the area, the lane information is displayed.

Vehicle navigation applications exist on the Internet or World Wide Web (WWW) The Internet is widely utilized in the retrieval of route information for navigation instructions. The World Wide Web is a graphic, interactive interface for the Internet (the term Internet is utilized interchangeably with Web throughout this specification). There are different computer program applications (web browser clients, referred hereinafter as web browser) on a data processing system connected to the Web that are utilized to access servers connected to the Web. Most navigation route planning applications are accessible via a home web page. Each web page has a unique address, or Universal Resource Locator (URL) with the Web that is accessible via Transfer Control Protocol/Internet Protocol (TCP/IP) transactions through telecommunication networks. The address allows a web browser to connect to and communicate with a Hyper Text Transfer Protocol (http) server over the Web. Upon accessing the URL, the user may request instructions to a specified destination by entering a beginning and ending location. The route with sequential road instructions appears. The application defines the route sequence given the users request for: shortest distance, shortest time, highway bypass, or toll bypass. In some applications the user is also given the opportunity to avoid seasonably closed thoroughfares.

The convenient use of route planning applications has allowed users to make efficient use of time and travel distance. However, as travel applications continue to grow, the available route options remain the same. There is presently no way of effectively providing a fuel-efficient route that a user can select during route planning that considers make, model, year, and fuel type of the motor vehicle. Additionally, current route planning applications do not evaluate geography of the terrain, frequency of stops, or traffic avoidance to render the most fuel-efficient route.

### SUMMARY OF THE INVENTION

Disclosed is a method for providing a sequence of travel instructions that reports fuel-efficient routes calculated with regard to vehicle specifications, geography of terrain, and complexity of travel route. An operator selects the desired starting and ending location via a client interface of a software application. When the user selects “most fuel efficient route,” the fuel-efficient route (FER) utility of the application prompts for entry of the make, model, and year of the operator's vehicle. If the FER utility is embedded in an in-car navigation system, the information about the vehicle characteristics is preprogrammed during installation (e.g., at the factory). The FER utility uses a number of metrics and the vehicle's characteristics, to generate an optimal route for efficient fuel consumption. Tie invention provides means for an operator of a route planning application to optimize the driving directions for optimally predicted fuel usage.

In one embodiment of the invention, the software application accesses the map database using a data processing system. The map database may be installed in the data processing system or accessed via the Web. The client interface of the application provides vehicle make, model, year, and fuel type menus. Next the user inputs the start and stop locations. Then, the fuel-efficient route (FER) utility searches the map database and calculates the route given the vehicle specifications, geography of terrain, and complexity of route. The utility first outputs travel instructions for the “most fuel-efficient” route. Finally, the user is given alternative travel instructions upon request.

In another embodiment, the start and destination locations are specified using a vehicle navigation system. The software application contains storage for a map database, a wireless communication system for passing data between the onboard computer and a remote server, an input/output device for providing a user interface between the onboard computer and the operator of the vehicle, and a vehicle sensor for providing motion-related signals to the onboard computer. Following operator initiation of a route planning application, the software utility performs the functions of accepting a planned route. The server administers the route over the wireless communication system. The utility reports the first most fuel-efficient route after evaluating vehicle specifications, geography of terrain, route complexity, and automatic feedback of average vehicle acceleration using motion-related signal inputs. The operator may choose to accept or decline the provided route instructions, or select the next most fuel-efficient route. Additionally, the current embodiment includes transmitting the selected destination to an external information server to obtain route traffic conditions.

In another embodiment, the invention provides a method for specifying a destination within a portable navigation apparatus and receiving fuel-efficient route directions. The route planning application is installed in the portable reader such as a palmtop computer, including storage for a map database, and an input/output device for providing a user interface between the portable reader and the operator of the vehicle. Utilizing a client interface, the operator selects the start and stop location. The FER utility accesses the map database and calculates fuel efficiency factoring in user defined vehicle specifications, geography of terrain, and complexity of route. The operator accepts or declines the provided route instructions, or selects the next most fuel-efficient route instructions utilizing the client interface. In this embodiment optional operator feedback of previous and current route fuel usage is available, to increase efficiency of fuel calculations. An advantage of this method is that travel instructions are obtained even if a positioning system, such as a Global Positioning System (GPS) satellite, is out of range, being initialized, or is not available. A server is not required to operate this embodiment of the system.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of the data processing system utilized to implement an illustrative embodiment of the present invention;

FIG. 2 is a diagram of the network of computers with Internet linked servers in accordance with an illustrative embodiment of the present invention;

FIG. 3 is a diagram illustrating the utilization of a vehicle navigation system in accordance to one embodiment of the present invention;

FIG. 4 is a block diagram of the onboard vehicle navigation system's route planning software architecture utilized to implement one embodiment of the present invention;

FIG. 5 is a logic flow chart illustrating the process of utilizing the data processing system to provide fuel-efficient travel instructions according to one embodiment of the present invention;

FIG. 6 is a logic flow chart illustrating the process of utilizing the onboard vehicle navigation system's route planning software application to provide fuel-efficient travel instructions according to one embodiment of the present invention;

FIG. 7A illustrates a graphical user interface for requesting most fuel-efficient route instructions, according to one embodiment of the invention; and

FIG. 7B illustrates a graphical display of the most fuel-efficient route instructions, according to one embodiment of the invention.

### DETAILED DESCRIPTION OF AN ILLUSTRATIVE EMBODIMENT

The present invention provides a method, system, and computer program product for retrieving a sequence of travel instructions that reports fuel-efficient routes calculated with regard to vehicle specifications, geography of terrain, and complexity of travel route. An operator selects the desired starting and ending location via a client interface of a software application. When the user selects “most fuel efficient route,” the fuel-efficient route (FER) utility of the application prompts for entry of the make, model, and year of the operator's vehicle. If the FER utility is embedded in an in-car navigation system, the information about the vehicle characteristics is preprogrammed during installation (e.g., at the factory). The FER utility uses a number of metrics and the vehicle's characteristics, to generate an optimal route for efficient fuel consumption. The invention provides means for an operator of a route planning application to optimize the driving directions for optimally predicted fuel usage.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

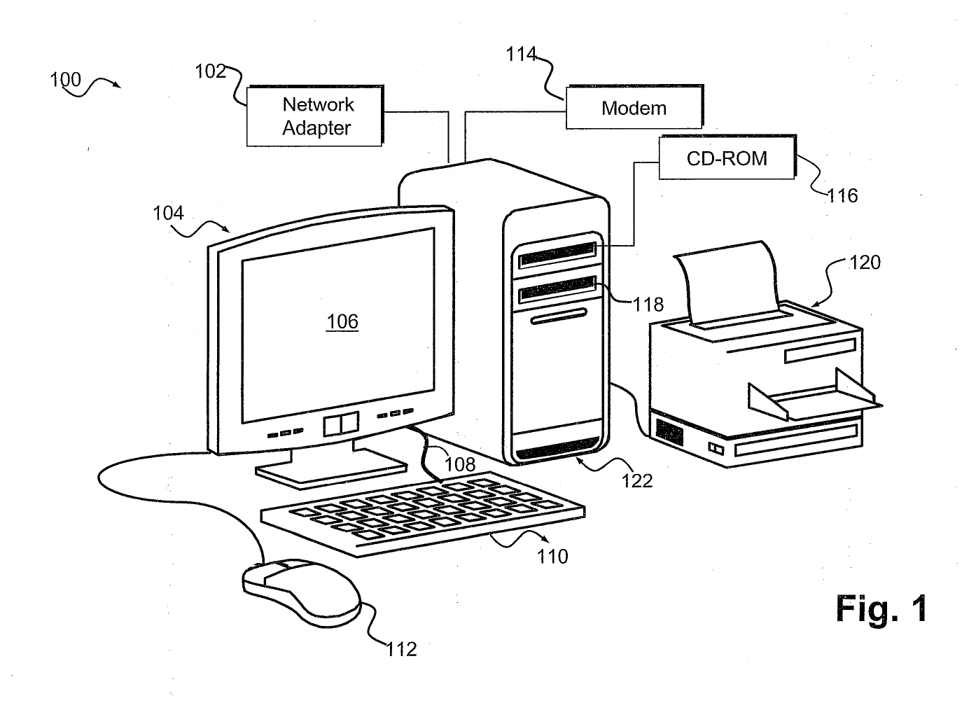

With reference now to the figures, and in particular with reference to FIG. 1, there is depicted the basic structure of a data processing system 100 utilized in one embodiment of the invention. Data processing system 100 has at least one central processing unit (CPU) or processor housed in casing 122. CPU is connected to several peripheral devices, including input/output devices such as a display monitor 104, keyboard 110, graphical pointing device 112, and printer 120 for user interface. Also housed in casing 122 are a permanent memory device (such as a hard disk) for storing the data processing system's operating system and user programs/applications, and a temporary memory device (such as random access memory or RAM) that is utilized by CPU to implement program instructions. CPU communicates with the peripheral devices by various means, including a bus or a direct channel (more than one bus may be provided utilizing a bus bridge).

Data processing system 100 may have many additional components, which are not shown such as serial, parallel, and USB ports for connection to, e.g., modems 114 or CD ROM 116. In the preferred embodiment of the invention, communication to data processing system 100 is made possible via modem 114 connected to a land line or wireless cellular telephone system which is in turn connected to a local network provider such as an Internet Service Provider (ISP). Additionally, data processing system 100 may be connected to a network via an Ethernet/network card or adapter 102. Communicated data arrives at the modem or network card and is processed and received by the data processing system's CPU or other software application.

Those skilled in the art will further appreciate that there are other components that may be utilized in conjunction with those shown in the block diagram of FIG. 1; for example, a display adapter connected to processor may be utilized to control video display monitor 106, and a memory controller may be utilized as an interface between temporary memory device and CPU. Data processing system 100 also includes firmware whose primary purpose is to seek out and load an operating system from one of the peripherals (usually permanent memory device) whenever the data processing system is first turned on. In the preferred embodiment, data processing system contains a relatively fast CPU along with sufficiently large temporary memory device and space on permanent memory device, and other required hardware components.

Conventional data processing systems often employ a graphical user interface (GUI) to present information to the user. The GUI is created by software that is loaded on the data processing system, specifically, the data processing system's operating system acting in conjunction with application programs. Two well-known GUIs include OS/2 (a trademark of International Business Machines Corp.) and Windows (a trademark of Microsoft Corp.).

Modem 114 can be utilized to connect data processing system 100 to an on-line information service or an Internet service provider. Such service providers may offer software that can be downloaded into data processing system 100 via modem 114. Modem 114 may also provide a connection to other sources of software, such as a server, an electronic bulletin board (BBS), or the Internet (including the World Wide Web).

The implementation of the present invention may occur on the data processing systems, described above. It is understood however, that other types of data processing systems are possible, which may have some or more of the basic components described above. In one embodiment, portable data processing systems are utilized during route planning as will be described below. These portable systems may include palmtops and laptops.

Various features of the invention are provided as software code stored within memory or other storage and executed by processor(s). Among the software code specific to the invention is code for enabling determination and retrieval of the most fuel-efficient route travel instructions. For simplicity, the collective body of code that enables retrieval of the most fuel-efficient route travel instructions is referred to herein as FER utility. In actual implementation, the FER utility may be added to existing route mapping or navigational application(s) to provide the various processes for enabling most fuel-efficient route functionality, as an available option.

The invention provides three major embodiments. First, the FER utility executes on a computer mapping device (e.g., a web-connected server or stand-alone data processing system) to allows operators to access a map database and request travel routing instructions from a source to a destination address, with most efficient fuel consumption. Second, a vehicle navigation system is enhanced with the FER utility to allow a user to specify a destination, and obtain travel/driving instructions/directions, with most efficient fuel consumption. Third, a vehicle navigation system is enhanced with both the FER utility and with vehicle sensor feedback data to permit the user to specify a destination, and obtain route instructions for most efficient fuel consumption. In the third embodiment, the vehicle sensor feedback data increases the effectiveness of fuel-efficient route calculations, given the actual operating characteristics of the vehicle. For clarity, the description of the invention is divided according to these three major embodiments, which are presented as: A. Computer based fuel-efficient route planning application; B. Fuel-efficient route planning utilizing a vehicle navigation system; and C. Fuel-efficient route planning utilizing a vehicle navigation system with vehicle feedback.

It is also understood that the use of specific parameter names are for example only and not meant to imply any limitations on the invention. The invention may thus be implemented with different nomenclature/terminology utilized to describe the above parameters, without limitation.

### A. Computer Based, Fuel-Efficient Route Planning Application

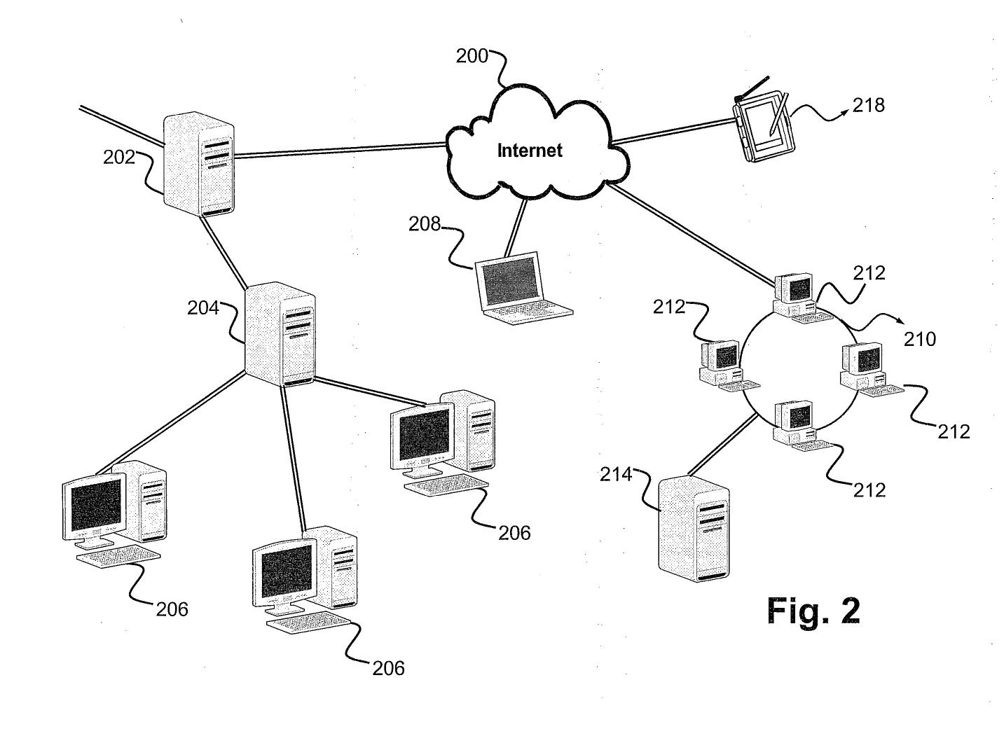

In one embodiment of the invention, a software application may be system installed or web accessible. A database of route instructions is made available on-line via the Internet at the web site of the route planning application. A user specifies start and stop locations for travel. The FER utility searches the map database and obtains the “most fuel-efficient” travel instructions. FIG. 2 illustrates the computer networks in which the computer based, fuel-efficient route planning application may be implemented.

FIG. 2 comprises a plurality of network servers 202, 204, and 214, and client computers 212 and 206. One main network server 202 operates as the memory storage location for the map database (including geography of terrain and route complexities), and as the memory storage location for vehicle information utilized within the invention. Main network server 202 may exist at the map provider site. Alternatively, main network server 202 may exist at server locations such as trucking/shipping companies and travel agencies.

Those skilled in the art are familiar with agencies that require interlinked network computers. Local server 204 and client network 210 are located in areas of high utilization. Companies of elevated driving volumes contain client computers 212. Client computers 212 are interlinked with main networked server 214 and store company vehicle specifications. Client computers 212 may be similarly configured as data processing system 100. In a non-web based application of the invention, the computer network may be a local area network (LAN).

As illustrated, main network server 202 is connected to Internet 200, which allows access to the web page of the route planning application stored on main network server 202 via a web browser application. A user of a web browser application can thus access the database maps and vehicle specifications. Web browser application may exist on a desktop computer (e.g. 206 or 212) as depicted in FIG. 1. However, in one embodiment, web browser applications exist on a portable laptop 208, as well as on a portable handheld (palmtop) computer 218 such as the Palm Pilot (manufactured by 3 Com), both of which have Internet access capability. In yet another embodiment, a cell phone having GPS capability and/or navigation features is further equipped with the FER utility to enable the features of the invention within the cell phone. The portability of the system/device in which FER utility is implemented is optional, as described in one of the embodiments of the invention described hereafter.

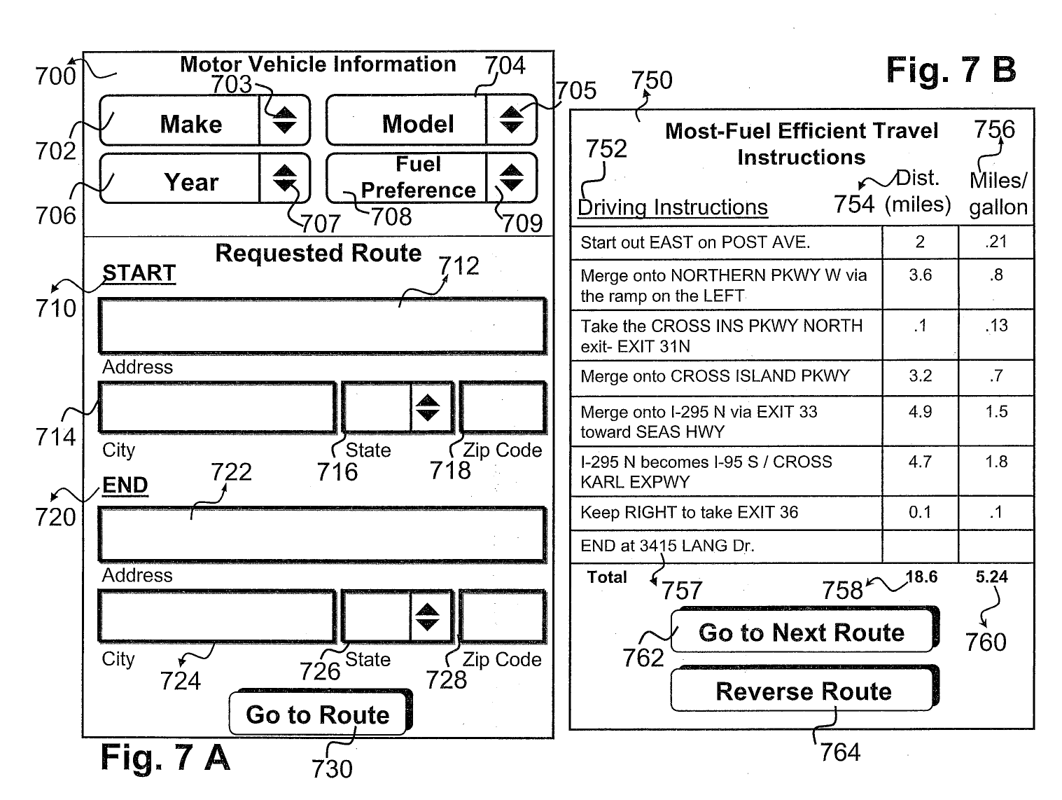

In another illustrative embodiment, a user enters the web site via his home-based client computer system and is presented with a graphical user interface (GUI), which includes entry fields generated for receiving information required by FER utility. FIG. 7A is an illustration of the client interface provided by the mapping software application, enhanced with FER utility. The client interface on the web page allows the user to enter motor vehicle information 700. The user first identifies make 702, model 704, year 706, and fuel preference 708 of the traveling vehicle. The vehicle specifications are provided in drop down menus 703, 705, 707, and 709. In one embodiment, the vehicle selections may include a drive type (automatic versus standard) selection and/or a selection of whether or not the vehicle is a HYBRID and/or the size of engine, for example, V8, V6, or V4. These metrics directly affect the fuel consumption rate regardless of whether the other metrics/characteristics (e.g., make and model) of the vehicle are known or provided. Next, the user identifies start location 710 and end location 720 of interest. The user first identifies start address 712, city 714, state 716, and zip code 718. Next, the user must identify end address 722, city 724, state 726, and zip code 728. After the user selects go to route instruction 730, the utility displays most fuel-efficient travel instructions. In another embodiment, if no vehicle information is available, default vehicle settings are utilized. The user only identifies the start and stop locations of interest.

FIG. 7B is a graphic display of most fuel-efficient travel instructions. In travel instructions display 750, the FER utility outputs driving directions 752, length of travel 754, and vehicle fuel consumption 756. The utility also displays the total distance of travel 758 and total vehicle fuel consumption 760. Driving directions 752 are followed by an option to view next most fuel-efficient route 762. Example driving directions 757 are illustrated. Additionally, the user is presented the opportunity to reverse the route of interest by selecting reverse route 764. Notably, the most fuel-efficient return route may be different given road conditions, terrain, and other driving factors that may change when driving in the opposite direction. The web site is interactive and immediately provides information on all applicable travel routes and available traffic reports.

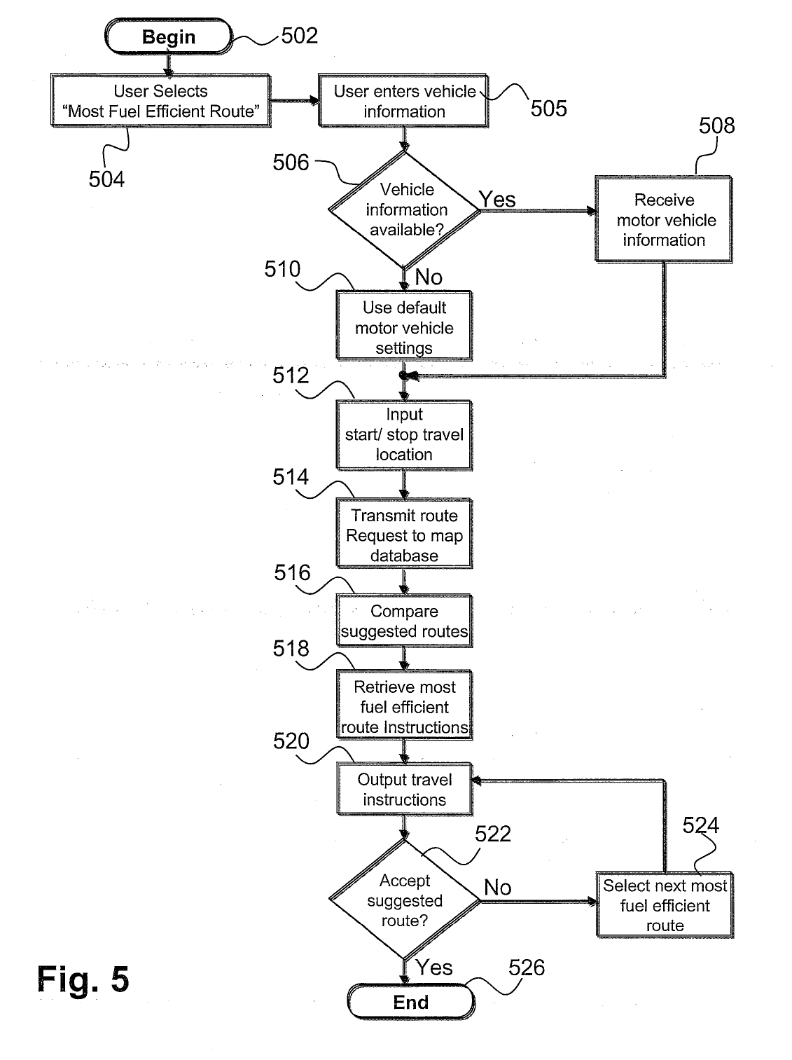

FIG. 5 depicts a method sequence for the computer-based or web-based fuel-efficient route planning application. The process begins at initiation step 502. In the computer-based embodiment, the utility first receives the user's selection to calculate the most fuel-efficient route in step 504. At step 505 the utility prompts the user to enter vehicle information. If vehicle information is available at step 506, the utility receives and processes the motor vehicle information at step 508. If the vehicle information is not available at step 506, the utility references the database for default vehicle settings at step 510. Proceeding to step 512, the utility prompts the user to enter the start and stop travel locations. On receipt of the user defined travel locations at step 512, the utility transmits the locations to the map database at step 514.

At step 516, the utility evaluates suggested routes based on vehicle data (from step 508 or 510), as well as complexity of the road network, frequency of stops, geography of terrain, and estimated vehicle speed. Evaluating vehicle specifications and suggested routes, the utility obtains the most fuel-efficient route instructions at step 518. The utility then outputs the most fuel-efficient travel instructions at step 520. The utility allows the user to accept or reject the suggested route at step 522. If the user does not accept the suggested route at step 522, then the utility continues to iterate through available fuel-efficient routes. The utility continues to select the next most fuel-efficient route instructions at step 524, until the user accepts the recommended route, or until no further routes are available. When the utility is prompted to accept the suggested route at step 522, the process ends (at step 526).

### B. Fuel-Efficient Route Planning Utilizing a Vehicle Navigation System

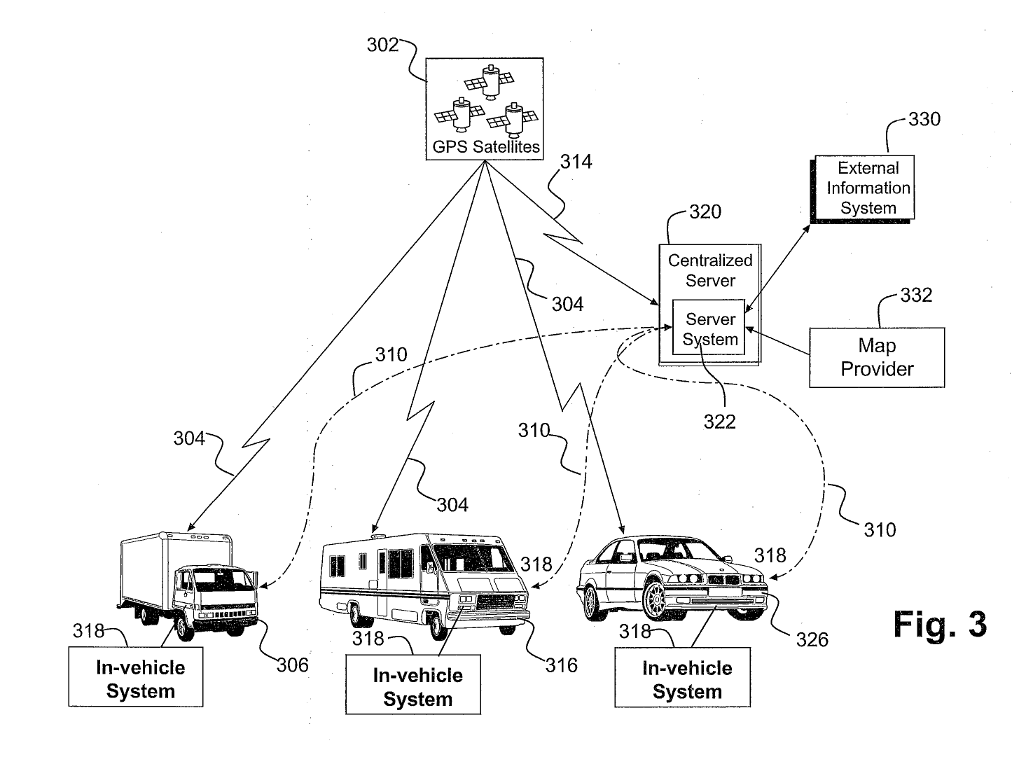

Referring to FIG. 3, in-vehicle information system 318 provides services, including a route planning and guidance (i.e., a “navigation”) service, to the operators of vehicles 306, 316, and 326, which are free to drive throughout a wide geographic area. To provide these services to the operators of vehicles 306, 316, and 326, in-vehicle information system 318 performs some functions in a server system 322 at a centralized server 320 that is at a fixed location. In-vehicle information system 318 performs other functions in in-vehicle information system 318 installed in each of vehicles 306, 316, and 326. In-vehicle information system 318 also includes a positioning system that provides a reference for estimating the locations of vehicles 306, 316, and 326 in absolute terms (i.e., in terms of their latitudes and longitudes). In particular, Global Positioning System (GPS) satellites 302 provide signals 304 that when received at vehicles 306, 316, and 326 enable the in-vehicle systems 318 to estimate their present locations.

Referring still to FIG. 3, centralized server 320 is “centralized” in that server 320 provides services at one location for vehicles that are distributed throughout a geographic area. The centralized server's location does not have to be “central” or even located in the same geographic area as the vehicles serviced by centralized server 320. Additionally, although the system is described in terms of a single centralized server 320, multiple servers can be used. When multiple servers are used, in-vehicle systems 318 can be configured to access particular servers for all, or for particular types of, service requests.

Referring still to FIG. 3, server system 322 relies on a map provider 332, which is a mapping information database. Map provider 332 provides information related to the road network, geography of terrain, and complexity of travel (e.g. traffic signals, stop and yield signs, and speed changes). A vendor of map-related information may provide map provider 332, as well as other map-related points of interest such as restaurants, gas stations, shopping malls, and city centers.

Additionally, FIG. 3 illustrates utilization of external information system 330. Server system 322 serves as a gateway to external information system 330. External information system 330 provides information utilized by server system 322, or provides information that is transmitted directly to in-vehicle systems 318. External information system 330 may provide traffic related information such as weather related road hazards, road construction, or traffic congestion (based on time of day or other factors). This information is utilized by server system 322 to determine the most fuel-efficient route.

In one embodiment, in-vehicle system 318 enables an operator of a vehicle (e.g. 306, 316, and 326) to specify a desired destination. Then, the navigation service enables the operator to be guided by the system to that destination via the most fuel-efficient route, while the operator is driving the vehicle. Additionally, the in-vehicle system 318 will suggest fuel-efficient routes based on user's optional input (e.g. no tolls and highways). In-vehicle system 318 tracks (i.e., repeatedly estimates) the position of the vehicle as the vehicle travels to the desired destination. In-vehicle system 318 also provides instructions to the operator to guide the operator to the desired destination. For instance, in-vehicle system 318 provides an instruction to make a turn at an upcoming intersection as the vehicle is approaching the intersection. Also, in-vehicle system 318 typically determines when the operator has made an error and the vehicle is off a planned route. If the vehicle is off route, in-vehicle system 318 provides the operator with instructions to continue to guide the vehicle to the destination, with a re-calculated most fuel-efficient route, despite the error.

In one embodiment, server system 322 provides various services to in-vehicle system 318, in a “client-server” arrangement in which in-vehicle systems 318 request services from server system 322. For instance, a fuel-efficient route planning function is performed by server system 322 at the request of in-vehicle system 318 while route guidance functions are performed by in-vehicle system 318.

In another embodiment in-vehicle system 318 is coupled to server system 322 by wireless communication links. In-vehicle system 318 typically operates in an autonomous mode after an initial exchange with server system 322. During the initial exchange, a starting location (or other location-related data), speed, and a desired destination are uploaded from the in-vehicle system 318 to the server system 322 and then a fuel-efficient route is downloaded from the server system 322 to the in-vehicle system 318. After travel instructions are downloaded to the in-vehicle system 318 from the server system 322, the in-vehicle system 318 does not require further interaction with the server system 322 to operate in its autonomous route guidance mode. While the vehicle is in autonomous route guiding mode, the in-vehicle system 318 can recover from an operator leaving the planned fuel-efficient route without requiring further communication with the server system 322.

In another embodiment, in-vehicle systems 318 receive signals 304 from GPS satellites 302 over radio frequency communication paths. Server system 322 also receives signals 314 from GPS satellites 302 over radio frequency communication paths. Data derived from signals 314 received by server system 322 from GPS satellites 302 are used by both server system 322 and in-vehicle systems 318 to improve the location estimates of vehicles 306, 316, and 326, for instance, using “differential” GPS calculations.

In another embodiment of the system, centralized server 320 also serves as a gateway to external information systems 330. These external systems provide information used by server system 322, or provide information that is passed directly to in-vehicle systems 318. For instance, external information system 330 can provide traffic-related information that is used by server system 322 to determine fuel-efficient travel instructions from a starting to a destination location. In another embodiment, external information system 330 can provide communication services to vehicle operators, such as traffic information.

In an alternate embodiment, alternative communication approaches between in-vehicle systems 318 and server system 322 can be used. Use of standard analog cellular telephone links is useful due to the broad geographic coverage in North America. In North America the infrastructure to support such links is available. In other parts of the world, digital cellular telephone links may be more appropriate, if the necessary infrastructure is available. A satellite-based communication system can alternatively be used to link the in-vehicle systems 318 to the server system 322. Also, other wireless data communication systems can be equivalently used to couple in-vehicle systems 318 and server system 322.

In another embodiment, alternative-positioning systems can be used rather than relying on signals from GPS satellites 302. For instance, a roadside optical or radio frequency beacon system can be used to provide location information to vehicles. Roadside beacon systems are not generally available in North America. However, the GPS-based approach provides broad geographic coverage.

### C. Fuel-Efficient Route Planning Utilizing an In-Vehicle Navigation System with Vehicle Feedback

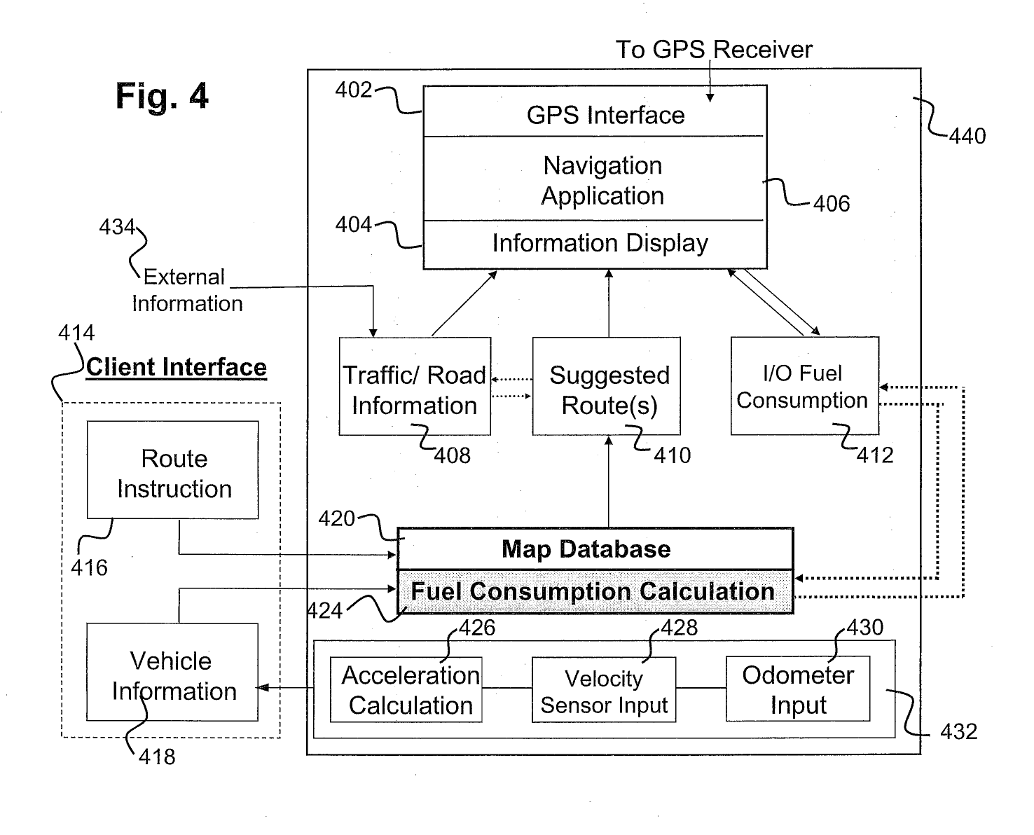

FIG. 4 is a block diagram illustrating an embodiment of the fuel-efficient route planning utility within a navigation system. The present fuel-efficient route planning utility includes vehicle feedback. The utility comprises two primary components: client interface 414 and planning utility 440. Client interface 414 obtains route instruction 414 from vehicle operator and accepts vehicle information 418 from sensor utility 432.

In one embodiment, the vehicle operator instructs planning utility 440 via client interface 414. At client interface 414, an operator enters destination location as route instruction 416. Vehicle information 418 is pre-stored or generated by sensor utility 432, and automatically fed into vehicle information 418. Route instructions 416 are transmitted to map database 420, and vehicle information 418 are transmitted to fuel consumption calculation utility 424. Information display 404 reports suggested fuel-efficient route(s) 410 of travel, fuel consumption 412, and optional traffic/road information 408.

In an optional embodiment of the system, the vehicle operator may provide fuel consumption information as entries to fuel consumption calculation utility 424, following completed route travel. Feedback of fuel consumption by the operator will increase the accuracy of subsequent route calculations provided by the fuel consumption calculation utility 424.

In another embodiment of the system, sensory information 426, 428, and 430 are continuously stored and presented to fuel consumption calculation utility 424 via vehicle information 418. In an alternate embodiment, sensor utility 432 data is presented to fuel consumption calculation utility 424 in real-time. Vehicle velocity sensors are connected to velocity sensor input 428. Odometer input 430 initializes at start of travel, reporting total distance traveled. Acceleration utility 426 calculates acceleration and transmits acquired information to vehicle information 418. Fuel consumption is calculated by fuel consumption calculation utility 424. The fuel consumption input is fed back into input/output (1/0) fuel consumption 412. I/O fuel consumption 412 maintains stored information on average fuel consumption for a given route, allowing more efficient route planning.

Referring still to FIG. 4, in another embodiment, map database 420 includes route instructions, terrain geography, and route complexities for calculation of the most fuel-efficient route(s). Map database 420 also provides information related to the road network, including the locations and types of road segments that interconnect to form the road network. An additional external information provider 434 provides other map-related information such as traffic or road information 408, as well as the locations of typical points of interest such as restaurants, gas stations, shopping malls, and city centers.

In another embodiment, planning utility 440 communicates with GPS satellites via GPS interface 402. GPS information is transmitted to the in-vehicle GPS receiver. Data derived from signals received by route planning utility 440 from GPS interface 402 is used at times to improve the location estimates of vehicle, by using “differential” GPS calculations (for instance).

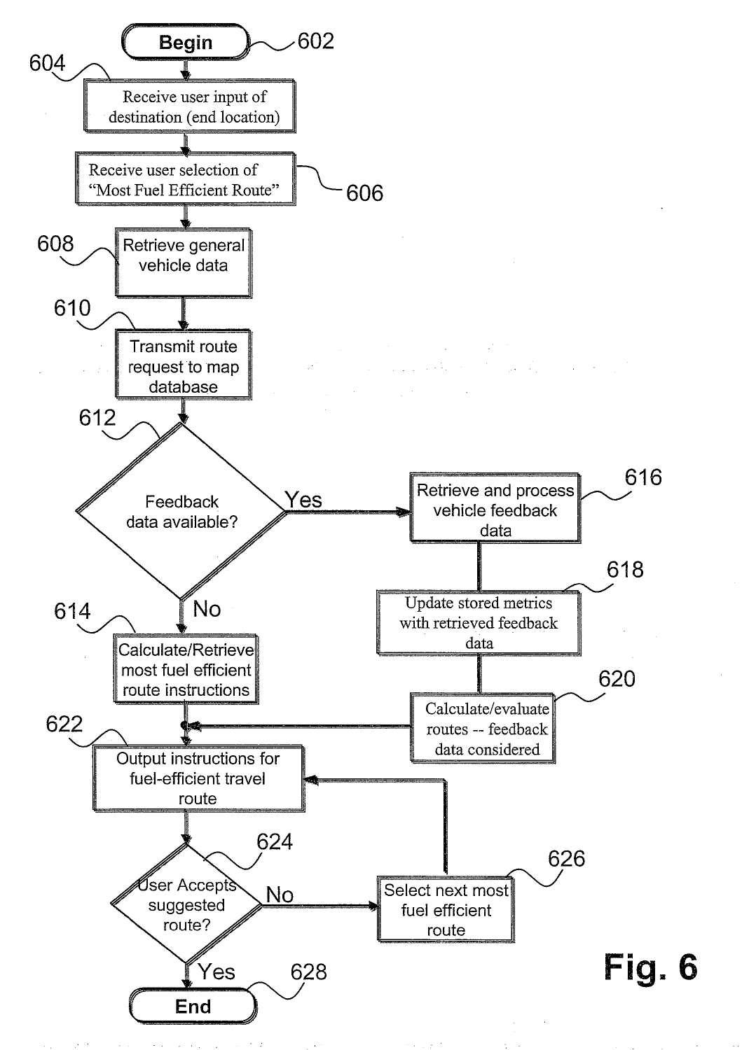

FIG. 6 illustrates a process for fuel-efficient route planning utilizing an in-vehicle navigation system with optional vehicle feedback. The process begins at initiation step 602. In the present embodiment, the utility first receives the user's input via the navigation system of a destination (end location) in step 604. Following the utility receives a selection from the user to provide the most fuel-efficient route, as shown in step 606. At step 608, the utility accesses pre-stored vehicle data (year, make, model, general fuel consumption rate). On receipt of the above user inputs and retrieve vehicle data, the utility transmits the information to the map database at step 610.

At step 612, the utility determines whether vehicle feedback data is available. Feedback data is collected from a series of sensors position within the vehicle and the data is stored for access by utility when later required. According to the embodiment, the feedback data is optional information. Vehicle sensor information includes driving and vehicle response patterns, such as vehicle acceleration, average speed, and average distance traveled per gallon of fuel, among other vehicle or driving metrics that may be tracked or monitored by an on-vehicle sensor.

If no vehicle feedback data is available, the utility calculates/evaluates the most fuel-efficient route to the destination using the pre-stored vehicle specifications (from step 608), and other store metrics, such as complexity of the road network, frequency of stops, geography of terrain, and estimated vehicle speed, as shown at step 614.

Assuming the vehicle feedback data is available, the utility retrieves and processes the vehicle feedback data at step 616, and, at step 618, the utility updates the stored metrics with the newly retrieved vehicle feedback data. Then, at step 620, the utility calculates/evaluates suggested routes based on vehicle feedback information (from step 616), vehicle data (from step 608), and other stored metrics, such as complexity of the road network, frequency of stops, and geography of terrain. Evaluating vehicle specifications, sensor information, and suggested routes, the utility obtains the most fuel-efficient route instructions (step 620).

At step 622, the utility outputs the most fuel-efficient travel instructions. The utility allows the user to accept or reject the suggested route at step 624. If the user does not accept the suggested route at step 624, then the utility selects the next most fuel-efficient route instructions at step 626. The utility continues to iterate through available fuel-efficient routes until the user accepts the recommended route, or until no further routes are available. Once the user accepts the suggested route at step 624, the route is tracked by the navigation system and the process ends at step 628.

In the flow charts above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogne communication links.

While the invention has been particularly shown and described with reference to a preferred embodiment, it will be understood by those skilled in the art that various changes in form and detail may be made therein without departing from the spirit and scope of the invention.

What is claimed is:

1. A method comprising:
receiving user input of a destination to which a route is desired to travel to the destination via a vehicle; and
determining a travel route to the destination, wherein said determining takes into consideration factors related to fuel consumption by the vehicle when traveling to the destination along various available paths, such that the travel route generated is a most-fuel efficient travel route among multiple available travel routes.

2. The method of claim 1, further comprising:
receiving a second user input of data identifying the vehicle being utilized to travel to the destination; and
wherein said determining further comprises evaluating the fuel consumption of the vehicle using the identifying data to retrieve fuel-consumption metrics of the vehicle, including make, model and year of the vehicle.

3. The method of claim 2, wherein said evaluating the fuel consumption comprises:
accessing a database of vehicle information, which database provides data related to the specific type of vehicle, including a size and weight of the vehicle, and a general fuel consumption rating of the vehicle.

4. The method of claim 2, further comprising:
receiving a third user input of a type of fuel being utilized by the vehicle; and
wherein said evaluating further comprises evaluating the fuel consumption of the vehicle using a “use rating” associated with the type of fuel specified by the third user input, wherein when a price per type of fuel is a data point within the database, said evaluating further evaluates the fuel consumption based on the cost of the type of fuel.

5. The method of claim 1, further comprising:
receiving a fourth user input of one or more metrics, which directly affect the fuel consumption rate regardless of whether vehicle identifying metrics are provided, said one or more metrics including one or more of a drive type, a fuel rating of the vehicle from among HYBRID and non-HYBRID, and a size of an engine of the vehicle; and
completing said determining by evaluating the fuel consumption of the vehicle using said fourth user input.

6. The method of claim 1, wherein said determining further comprises:
retrieving each of the available travel routes to the specified destination; and
performing an evaluation of the fuel consumption based on characteristics of each of the retrieved travel routes, said characteristics comprising: number of stop lights, amount of traffic, time of travel, grade of roadway surfaces, speed limit of roadways, slope/grade of terrain, average speed, estimated travel time, and total distance.

7. The method of claim 1, wherein when information about the available travel routes is not locally maintained, the determining further comprises:
accessing a remote database of route information; and
retrieving required data from the remote database.

8. The method of claim 6, wherein the user enters the request in a navigation system within the vehicle, and wherein said accessing further comprises:
accessing a location-based wireless communication system to determine a current location of the vehicle;
automatically retrieving general vehicle information from a local storage;
determining if feedback data is available from sensors within the vehicle;
when feedback data is not available, performing the determining step with the retrieved vehicle information; and
when feedback data is available, performing the determining step with the retrieved vehicle information and the feedback data to yield a more accurate analysis of the vehicle fuel consumption given the actual vehicle characteristics and driving characteristics.

9. The method of claim 1, further comprising:
outputting the most fuel-efficient travel route to an output device; and
when the output device is a display device of a navigational system:
plotting the most fuel-efficient route on the display device; and
responsive to a divergence by vehicle from the most-fuel efficient route, determining a next most fuel-efficient route to the destination from the current location of the vehicle and plotting the next most fuel-efficient route on the display device.

10. A computer program product comprising:
a computer readable medium; and
program code on the computer readable medium that when executed by a processor on a computer device provides the functions of:
receiving user input of a destination to which a route is desired to travel to the destination via a vehicle; and
determining a travel route to the destination, wherein said determining takes into consideration factors related to fuel consumption by the vehicle when traveling to the destination along various available paths, such that the travel route generated is a most-fuel efficient travel route among multiple available travel routes.

11. The computer program product of claim 10, further comprising program code for:
receiving a second user input of data identifying the vehicle being utilized to travel to the destination; and
wherein said determining further comprises evaluating the fuel consumption of the vehicle using the identifying data to retrieve fuel-consumption metrics of the vehicle, including make, model and year of the vehicle;
wherein said program code for evaluating the fuel consumption comprises code for accessing a database of vehicle information, which database provides data related to the specific type of vehicle, including a size and weight of the vehicle, and a general fuel consumption rating of the vehicle.

12. The computer program product of claim 11, further comprising program code for:
receiving a third user input of a type of fuel being utilized by the vehicle;
when said third user input is received, said program code for evaluating further comprises code for evaluating the fuel consumption of the vehicle using a “use rating” associated with the type of fuel specified by the third user input, wherein when the price per type of fuel is a data point within the database, said evaluating further evaluates the fuel consumption based on the cost of the type of fuel;
receiving a fourth user input of one or more metrics, which directly affect the fuel consumption rate regardless of whether vehicle identifying metrics are provided, said one or more metrics including one or more of a drive type, a fuel rating of the vehicle from among HYBRID and non-HYBRID, and a size of an engine of the vehicle; and
when said fourth user input is received, completing said determining by evaluating the fuel consumption of the vehicle using said fourth user input.

13. The computer program product of claim 9, wherein said determining code further comprises code for:
retrieving each of the available travel routes to the specified destination; and
performing an evaluation of the fuel consumption based on characteristics of each of the retrieved travel routes, said characteristics comprising: number of stop lights, amount of traffic, time of travel, grade of roadway surfaces, speed limit of roadways, slope/grade of terrain, average speed, estimated travel time, and total distance.

14. The computer program product of claim 13, wherein the user enters the request in a navigation system within the vehicle, wherein said program code for accessing further comprises code for:
accessing a location-based wireless communication system to determine a current location of the vehicle;
automatically retrieving general vehicle information from a local storage;
determining if feedback data is available from sensors within the vehicle;
when feedback data is not available, performing the determining step with the retrieved vehicle information; and
when feedback data is available, performing the determining step with the retrieved vehicle information and the feedback data to yield a more accurate analysis of the vehicle fuel consumption given the actual vehicle characteristics and driving characteristics.

15. The computer program product of claim 9, further comprising program code for:
outputting the most fuel-efficient travel route to an output device; and
when the output device is a display device of a navigational system:
plotting the most fuel-efficient route on the display device; and
responsive to a divergence by the vehicle from the most-fuel efficient route, determining a next most fuel-efficient route to the destination from the current location of the vehicle and plotting the next most fuel-efficient route on the display device.

16. A navigation system comprising:
a processor component;
a user interface that enables entry by a user of a user request for destination routing information and which displays a generated travel route; and
a utility executing on the processor component and which comprises codes that enable completion of the following functions:
receiving user input of a destination to which a route is desired to travel to the destination via a vehicle;
retrieving each of the available travel routes to the specified destination, wherein when information about the available travel routes is not locally maintained, the code for retrieving further comprises code for:
accessing a remote database of route information; and
retrieving required data from the remote database;
performing an evaluation of the fuel consumption based on characteristics of each of the retrieved travel routes, said characteristics comprising: number of stop lights, amount of traffic, time of travel, grade of roadway surfaces, speed limit of roadways, slope/grade of terrain, average speed, estimated travel time, and total distance; and
determining a travel route to the destination, wherein said determining takes into consideration factors related to fuel consumption by the vehicle when traveling to the destination along various available paths, such that the travel route generated is a most-fuel efficient travel route among multiple available travel routes.

17. The navigation system of claim 16, wherein said utility further comprises code for:
receiving a second user input of data identifying the vehicle being utilized to travel to the destination;
wherein said determining further comprises evaluating the fuel consumption of the vehicle using the identifying data to retrieve fuel-consumption metrics of the vehicle, including make, model and year of the vehicle;
wherein said program code for evaluating the fuel consumption comprises code for:
accessing a database of vehicle information, which database provides data related to the specific type of vehicle, including a size and weight of the vehicle, and a general fuel consumption rating of the vehicle.

18. The computer program product of claim 16, further comprising program code for:
receiving a third user input of a type of fuel being utilized by the vehicle;
when the third user input is received, completing the evaluating of the fuel consumption by the vehicle using a “use rating” associated with the type of fuel specified by the third user input, wherein when the price per type of fuel is a data point within the database, said evaluating further evaluates the fuel consumption based on the cost of the type of fuel;
receiving a fourth user input of one or more metrics, which directly affect the fuel consumption rate regardless of whether vehicle identifying metrics are provided, said one or more metrics including one or more of a drive type, a fuel rating of the vehicle from among HYBRID and non-HYBRID, and a size of an engine of the vehicle; and
when the fourth user input is received, completing said determining by evaluating the fuel consumption of the vehicle using said fourth user input.

19. The navigation system of claim 16, wherein the navigation system is an in-vehicle navigation system, wherein said code for accessing further comprises code for:
accessing a location-based wireless communication system to determine a current location of the vehicle;
automatically retrieving general vehicle information from a local storage;
determining if feedback data is available from sensors within the vehicle;
when feedback data is not available, performing the determining step with the retrieved vehicle information; and
when feedback data is available, performing the determining step with the retrieved vehicle information and the feedback data to yield a more accurate analysis of the vehicle fuel consumption given the actual vehicle characteristics and driving characteristics.

20. The navigation system of claim 16, further comprising code for:
outputting the most fuel-efficient travel route to an output device; and
when the output device is a display device of a navigational system:
plotting the most fuel-efficient route on the display device; and responsive to a divergence by the vehicle from the most-fuel efficient route, determining a next most fuel-efficient route to the destination from the current location of the vehicle and plotting the next most fuel-efficient route on the display device.
